(19) United States
(12) Patent Application Publication
(10) Pub. No.: US 2005/0223577 A1
(43) Pub. Date: Oct. 13, 2005

(54) Removable level end caps

(76) Inventor: Dane Scarborough, Hailey, ID (US)

Correspondence Address: STEPHEN M. NIPPER;DYKAS, SHAVER & NIPPER, LLP, PO BOX 877, BOISE, ID, 83701-0877, US

(21) Appl. No.: 11/104,286

(22) Filed: Apr. 12, 2005

Related U.S. Application Data
(60) Provisional application No. 60/561,965, filed on Apr. 13, 2004.

(51) Int. Cl. G01C 9/00

(52) U.S. Cl. 33/379; 248/467; 33/365; 33/451

(57) ABSTRACT

A level end cap for protecting a level body from damage. The level body having a first end. Defined within the first end is a plurality of holes therethrough. The end cap having an internal portion and an external portion. The external portion for protecting the end cap. The internal portion having extending therefrom an internal flange. Extending from the internal flange is a plurality of detents configured for extending through the plurality of holes in the body, thereby locking the end cap on the level body.

### PRIORITY

This application is a non-provisional application which claims the priority date from the provisional application entitled REMOVABLE LEVEL END CAPS filed by Dane Scarborough on Apr. 13, 2004 with application Ser. No. 60/561,965, the disclosure of which is incorporated herein by reference.

### DESCRIPTION

### BACKGROUND OF THE INVENTION

1. Field of the Invention

The present invention generally relates to spirit levels, and more particularly relates to spirit level end caps.

2. Background Information

Construction levels typically comprise a generally hollow length of rectangular tubing having hard plastic end caps that are friction fitted into the ends of said tubing. These hard end caps are for protecting the level against impact. However, being a hard rubber material, absorption of shock is less than perfect.

Additionally, there are times when it is desirable to make the end caps removable. When a friction fit is used, removal is all but impossible.

What is needed is a way of using a softer rubber end cap and a manner of mounting the end caps within the ends so they are easily removable. The present invention solves these needs.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a removable end cap for a level. The end cap having at least one flange extending within the body of the level. Extending from this flange is a detent configured for extending out of a hole in the body of the level. Thus, by pushing in on the detent, the end cap can be disengaged from the level and removed.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of one embodiment of the present invention.

FIG. 2 is a first end view of the embodiment of FIG. 1.

FIG. 3 is a first side view of the embodiment of FIG. 1.

FIG. 4 is a top view of the embodiment of FIG. 1.

FIG. 5 is a partial, environmental, perspective view of a second embodiment of the present invention.

FIG. 6 is a top view of a third embodiment of the present invention.

FIG. 7 is an exploded, side view of the embodiment of FIG. 5.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is a removable, protective end cap for a construction (spirit) level. Construction levels are frequently configured having a generally parallelepipedal first end extending to a generally parallelepipedal second end. This structure typically forming a generally rectangular hollow tube (at least at the ends of the level). Traditionally, hard plastic or hard rubber end caps are inserted into these open ends and are affixed therein through use of various means including adhesives, crimps, friction fits, etc. These end caps not configured for removal, but intended for generally permanent attachment.

The present invention is an improved, removable end cap as well as an improved level having such removable end caps. There are a number of reasons for having removable end caps, including, but not limited to using the inside portion of the level for storage, and the desire to have a shorter level (for instance if a user desires to mark a four foot window sill, the user could remove the end caps from a four foot level (with the end caps the level would be longer than four feet long) and use the body of the level as a marking guide, etc.).

While the present invention is intended as a level end cap, obviously the teachings of the present invention can be used throughout various other art units where “end caps” and associated closures/protectors are used. For instance, removable round end caps could be created following the teachings of the present invention for protecting the ends of pipes and other such structure.

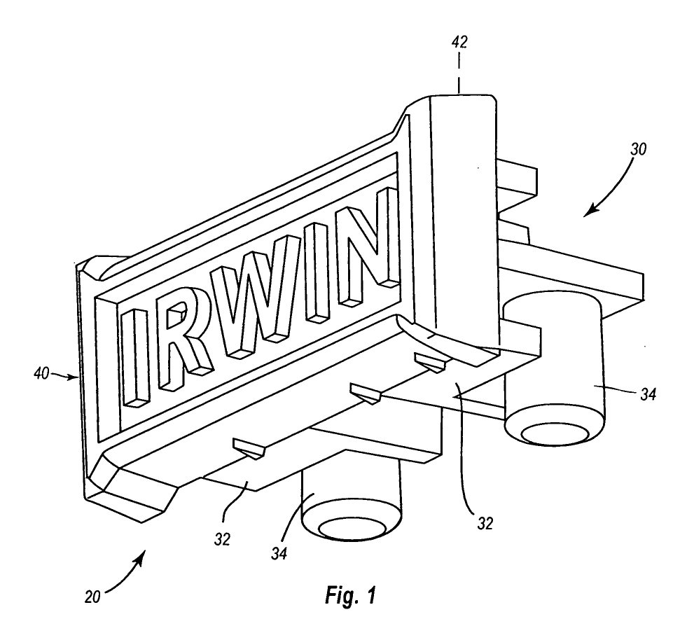

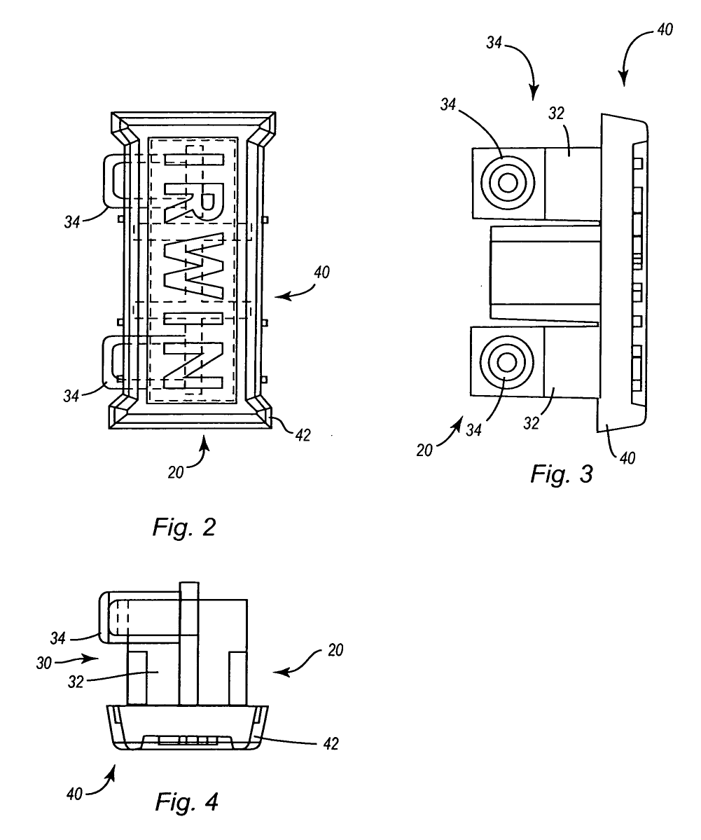

Referring initially to FIGS. 1-4, shown is one embodiment of such an improved level end cap. Such a level having a generally tubular structure allowing an end cap to be partially inserted therein. The end cap 20 shown in this preferred embodiment having an internal portion 30 attached to an external portion 40. It is preferred that the portions be molded together, however other manners of attaching them together is likewise envisioned, including, but not limited to adhesives, welds, molding, fasteners and the like.

The purpose of the internal portion 30 is for attaching the end cap to the level as well as in providing support for the external portion. The internal portion is configured for being removable so that a user can easily, preferably without the use of tools, remove the end cap from the level. This internal portion 30 having at least one flange 32 extending (when installed) into the hollow tubular structure of the level. It is preferred that extending from this flange are one or more detents 34. The detents 34 shown being generally circular tubular in shape extending from only one side of the flange. Obviously these detents could likewise extend from multiple or both sides of the flange. These detents 34 are configured for receipt into a hole (call-out number 16 in FIG. 7) defined within the sidewall of the level (discussed infra.).

It is preferred that a living hinge or other structure be configured within the flange/detent so that the detent can be moved or depressed relative to the external portion. This is important for allowing a user to use his/her finger or another device to depress the detent back within the level's hollow tube when installed, thereby unlocking the end cap and allowing the end cap to be removed from the level. This feature is further discussed later in this application.

It is preferred that that the internal portion substantially abuts an inner surface of the open end of the level end, thereby preventing the removable end cap from twisting, moving, or being removed during use.

The end cap 20 further comprising an external portion 40. This external portion 40 attaching to the internal portion 30. This external portion 40 configured for protecting the end of the level body from damage. This external portion 40 having a protective extension 42 extending therefrom. This protective extension 42 can be so sized as desired by the manufacturer to provide the type of protection so desired.

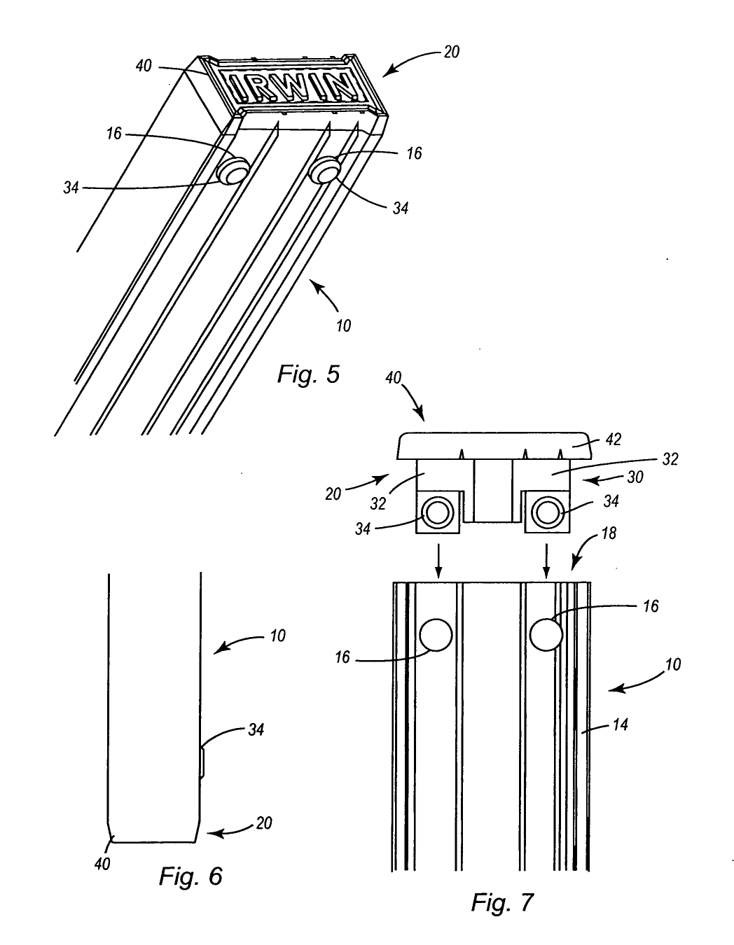

Referring now to FIGS. 5 and 6, shown are views of the present invention as installed upon a level 10. While within this disclosure it is often discussed as the present invention being the end cap itself, obviously the present invention is likewise the combination of the end cap and the level body itself. These figures showing the end cap 20 inserted within the open first end (call-out number 18 in FIG. 7) of the level, with the detent(s) 34 extending through holes 16 within the sidewall 14 of the level's body.

Referring particularly now to FIG. 7, shown is an exploded view of FIG. 5 showing the end cap removed from the level body. The level 10 comprising a hollow tube having a sidewall 14. Defined within the sidewall 14 are a number of holes (detent apertures) 16 therethrough. This hollow tube level body having an open first end 18 into which the end cap can be inserted. This end cap having an internal portion 30 attaching to an external portion 40. The internal portion having a pair of flanges 32, each having a pair of detents 34 extending therefrom. The external portion 40, of course, having a protective extension 42 therefore protecting the level from damage. Preferably, this protective extension 42 forms an exterior cap matching substantially an end periphery of a level to prevent damage to said end periphery of said level.

While the embodiment shown in FIG. 6 shows the detent extending beyond the flush side surface of the level, it is likewise envisioned that this extension could be generally flush with the sidewall of the level and not extend therefrom. The detent (if configured to extend far enough away from the level body) can serve as a non-slip surface for the level when the level is engaged with a working surface. As such, the end caps can be configured so that when light pressure is applied to the detent(s) (for instance when the level is pressed against a surface), the detent recedes back into the level. If the detents are pressed even further into the level, the end cap will be unlocked from its engagement with the holes in the level and the end cap can be withdrawn out of the level.

It is preferred that the detents be located on one or both of the faces of the level. A level traditionally has a front face, a back face, a topside, a bottom side and two ends. The top and/or bottom sides bearing measuring indicia. The present invention (in the embodiment where the detents extend outwards from the side of the level) is particularly configured for being held against a surface (such as a wall) by a user, the user able to press the level against the wall, thereby engaging the detents against the wall, these detents to some extent thereby being withdrawn back into the level's body (preferably due to the living spring or other structure). Because the detents are at least minimally engaging the wall, the level will hold its position on the wall and not be inclined to slide down the wall. As such, a user could make a straight mark on the wall by running a marking device such as a pencil along the junction of the wall, the topside and the back side of the level (which is being held generally flush with the wall).

The present invention is further a dual configuration construction level for indicating to a user when a surface is level. This construction level is convertible from a short-mode to a long-mode. Such a level having a generally parallelepipedal level body having an open first end opposing an open second end, and four sides. At least one of the sides having at least one first hole defined therethrough adjacent to the first end and at least one of the sides having at least a second-hole defined therethrough adjacent to the second end.

The level having a first end cap, this first end cap having an internal portion and an external portion. The external portion for protecting the first end from impact. The internal portion for insertion into the open first end. The internal portion having a first detent configured for extending into the first hole thereby locking the first end cap onto the level body at the first end.

The level further having a second end cap, this second end cap having an internal portion and an external portion. This external portion for protecting the second end from impact. This internal portion for insertion into the open second end. The internal portion having a second detent configured for extending into the second hole thereby locking the second end cap onto the level body at the second end.

These end caps can be detached from the level body by manually pushing the detents through the holes and into the level body, and pulling the end caps out of the open ends, thereby converting the level into its short-mode. Wherein these said first and second end caps can be attached to the level body by manually pushing the end caps into the ends, the detents automatically extending into the holes thereby locking the end caps in the ends, thereby converting the level into its long-mode.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A removable level end cap for protecting a level body from damage, said level body having an open first end, defined adjacent said first end is at least one hole extending through said level body, said end cap comprising:
an internal portion configured for insertion into said level body open first end, said internal portion having extending therefrom at least one detent configured for extending into said hole, said detent thereby locking said end cap on said level body; and
an external portion attaching to said internal portion, said external portion for protecting said end cap first end from damage.

2. The end cap of claim 1, wherein said end cap can be removed from said level body by pushing said detent through said hole back into said level body and then pulling said end cap out of said first end.

3. The end cap of claim 1, wherein a living hinge is used to attach said detent to said internal flange.

4. The end cap of claim 1, wherein said detent extends through said hole and outside of said level body.

5. A removable level end cap comprising:
an exterior cap matching substantially an end periphery of a level to prevent damage to said end periphery of said level; and
an internal portion of said removable level end cap for insertion into an open end of said level comprising at least one detent for attaching said removable level end cap to at least one detent aperture defined by said level.

6. The removable end cap of claim 5, wherein said at least one detent provides a non-slip surface when fixedly attached to said level.

7. The removable end cap of claim 5, wherein said at least one detent is flush with an external surface of said level when fixedly attached.

8. The removable end cap of claim 5, wherein said removable end cap may be removed by depressing said at least one detent while extracting said removable end cap.

9. The removable end cap of claim 5, wherein said at least one detent automatically secures said removable end cap to said level when said interior portion is inserted into said open end of said level.

10. The removable end cap of claim 5, wherein said internal portion substantially abuts an inner surface of said open end of said level end preventing said removable end cap from moving during use.

11. A dual configuration construction level for indicating to a user when a surface is level, said construction level convertible from a short-mode to a long-mode, said level comprising:
a generally parallelepipedal level body having an open first end opposing an open second end, and four sides, at least one of said sides comprising at least one first hole defined therethrough adjacent to said first end, at least one of said sides comprising at least one second hole defined therethrough adjacent to said second end;
a first end cap, said first end cap comprising an internal portion and an external portion, said first end cap external portion for protecting said first end from impact, said first end cap internal portion for insertion into said open first end, said first end cap internal portion comprising a first detent configured for extending into said first hole thereby locking said first end cap onto said level body at said first end; and
a second end cap, said second end cap comprising an internal portion and an external portion, said external portion for protecting said second end from impact, said internal portion for insertion into said open second end, said internal portion comprising a second detent configured for extending into said second hole thereby locking said end cap onto said level body at said second end;
wherein said end caps can be detached from said level body by manually pushing said detents through of said holes and into said level body, and pulling said end caps out of said open ends, thereby converting said level into its short-mode;
wherein said first and second end caps can be attached to said level body by manually pushing said end caps into said ends, said detents automatically extending into said holes thereby locking said end caps in said ends, thereby converting said level into its long-mode.
